(19) United States
(12) Patent Application Publication
(10) Pub. No.: US 2024/0312104 A1
(43) Pub. Date: Sep. 19, 2024

(54) VIRTUAL REALITY MEMORY BANK AND METHOD FOR THE SAME

(71) Applicants: Xerxes A. Mangapit, Yardley, PA (US); Andrew A. Kush, Yardley, PA (US)

(72) Inventors: Xerxes A. Mangapit, Yardley, PA (US); Andrew A. Kush, Yardley, PA (US)

(21) Appl. No.: 18/238,690

(22) Filed: Aug. 28, 2023

Related U.S. Application Data
(60) Provisional application No. 63/451,691, filed on Mar. 13, 2023.

(51) Int. Cl. G06T 15/00; G06F 21/62

(52) U.S. Cl. CPC G06T 15/00; G06F 21/6218

(57) ABSTRACT

A virtual reality memory bank is shown and described. The virtual reality memory bank allows a user to use virtual reality devices in order to revisit their home or a familiar place to view pictures and videos shared via a web application by another user. The device will display a room containing various media items, such as: picture frames, a television, a radio, and superimposed links meant for advertising or e-commerce. Users will be able to upload appropriate media for the user to see using these media items. In some versions, the user's living room or other favorite room is digitized and personalized. This will place the user in said room when using the virtual reality memory bank.

### CROSS REFERENCE TO RELATED APPLICATIONS

This application claims the benefit of U.S. Provisional Application No. 63/451,691, filed on Mar. 13, 2023. The above identified patent application is herein incorporated by reference in its entirety to provide continuity of disclosure.

### BACKGROUND OF THE INVENTION

The present invention relates to storing and viewing memories. More particularly, the present invention allows a user who may be in assisted living or had to move away from their lifelong home to revisit their home, a close family member's home, or a familiar place and view media items shared by friends and family.

As individuals get older it is common practice to move into assisted living homes. Typically, when all occupants move out the house is then sold. One of the common issues with moving into such a home is leaving behind everything that is familiar. Further, an individual may have lived in their previous residence for an extended period of time. This will undoubtedly create attachments. Currently, when a person leave their residence it is difficult to revisit the same.

In other instances individuals may not be leaving permanently but for extended periods of time. For example an individual leaving for college may not return to their childhood home for many months at a time. They may miss their bedroom or other living spaces.

When an individual leaves home they may also be leaving behind pictures or other items which have been placed around creating memories. It may be difficult to take these items to one's new living location due to size and storage restrictions. This means these items would have to be left behind.

In other instances as an individual ages they may miss out on being able to visit familiar spaces, or even exciting new ones. Older individuals may not be able to travel much or at all. Further, even if some individuals are able to travel they may need to travel with medical personnel or equipment. This may lead them to not wish to travel or visit places, new or old. These individuals will most likely begin to miss familiar places which may lead to sadness. Currently, there is no way of sharing these places with individuals who have trouble traveling or do not wish to travel due to complications.

Consequently, there is a need for an improvement in the art of assisted living and transitioning away from one's home or other extended absences from home. The present invention substantially diverges in design elements from the known art while at the same time solves a problem many people face when transitioning away from their home to a new environment. In this regard the present invention substantially fulfills these needs.

### SUMMARY OF THE INVENTION

The present invention provides a virtual reality memory bank and method for using the same wherein the same can be utilized for providing convenience for the user when wishing to view memories of people or places. A method for a virtual reality memory bank. The method begins by creating a 360-degree virtual location, wherein the virtual location is displayed on a virtual reality headset. The 360-degree virtual location includes at least one visual media outlet. Next visual media is displayed via at least one visual media outlet. The 360-degree virtual location includes at least one audible media outlet. Next audible media is played via the at least one audible media outlet.

Another object of the method for a virtual reality memory bank includes creating the 360 degree virtual location from a physical location.

Another object of the method for a virtual reality memory bank includes having the visual media outlet be a television.

Another object of the method for a virtual reality memory bank includes having the audible media outlet be a radio.

Another object of the method for a virtual reality memory bank includes taking a 360-degree photograph of a physical location; and having the 360-degree virtual location is created using the 360-degree photograph.

Another object of the method for a virtual reality memory bank includes having access to the 360-degree virtual location be restricted.

Another object of the method for a virtual reality memory bank includes accessing the 360-degree virtual location via a user name and password.

Another object of the method for a virtual reality memory bank includes having multiple persons having access to a single 360-degree virtual location;

Another object of the method for a virtual reality memory bank includes having different persons having different access permissions.

Another object of the method for a virtual reality memory bank includes having selected persons given the ability to add selected media assets to a virtual database for display via at least one of the visual media outlet and the audible media outlet.

Another object of the method for a virtual reality memory bank includes selecting virtual items displaying within the 360-degree virtual location to be interactive.

Another object of the method for a virtual reality memory bank includes selecting a desired action which will be performed when the virtual item is selected.

Another object of the method for a virtual reality memory bank includes creating a second 360-degree virtual location, wherein the second 360-degree virtual location is accessible via the 360-degree virtual location.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a screen capture of one embodiment of a room created for us on virtual reality device of the virtual reality memory bank.

FIG. 2 shows a screen capture of another embodiment of a room created for us on virtual reality device of the virtual reality memory bank.

FIG. 3 shows a flow chart of one embodiment of creating a profile for the virtual reality memory bank.

FIG. 4 shows a flow chart of one embodiment of adding media to the system to be displayed by the virtual reality memory bank.

FIG. 5 shows a flow chart of one embodiment of adding a user to the system for the virtual reality memory bank.

FIG. 6 shows a flow chart of one embodiment of managing the virtual reality experience of the virtual reality memory bank.

FIG. 7 shows a flow chart of one embodiment of enhancing the virtual reality experience of the virtual reality memory bank.

FIG. 8 shows a flow chart of an embodiment of a method for creating a custom room and granting access to the same.

FIG. 9 shows a wiring diagram of an embodiment of a virtual reality system.

### DETAILED DESCRIPTION OF THE INVENTION

Reference is made herein to the attached drawings. Like reference numerals are used throughout the drawings to depict like or similar elements of the virtual reality memory bank. For the purposes of presenting a brief and clear description of the present invention, a preferred embodiment will be discussed as used for the virtual reality memory bank. The figures are intended for representative purposes only and should not be considered to be limiting in any respect.

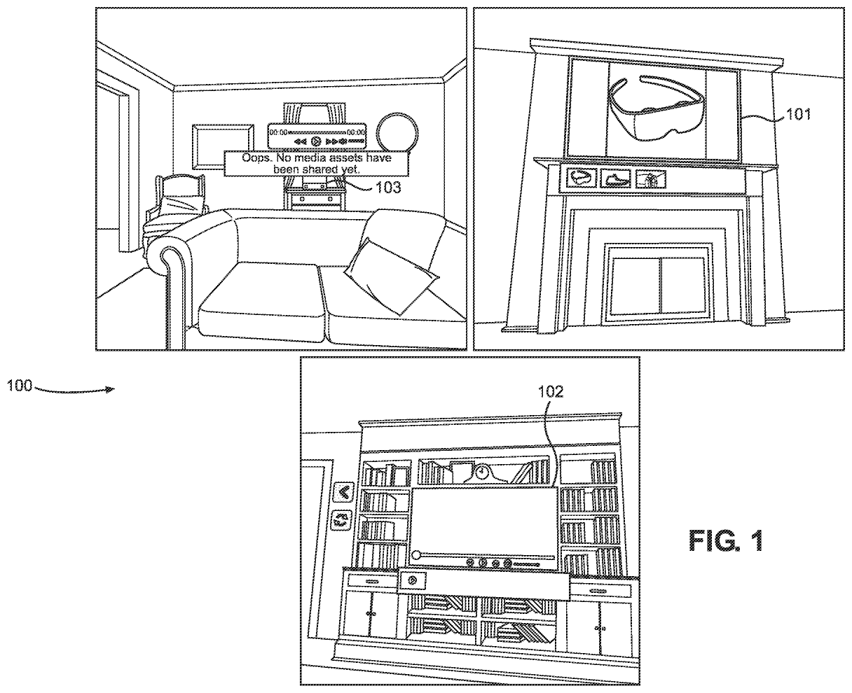

Referring now to FIG. 1, there is shown a screen capture of one embodiment of a room created for us on virtual reality device of the virtual reality memory bank. As the room is a 360-degree environment multiple flat view screen captures are required to show the space. In one embodiment the room 100 is a custom created virtual space that resembles a room or other favorite space of the user. For example, the room 100 could be a user's living room or kitchen. In another embodiment the room could be a park. In another embodiment the room 100 is not from a user's life, but a custom-made space which allows a user to still be surrounded by chosen media as described below.

In one embodiment these spaces may be created using photos. In another embodiment, a 360 degree photo is used to create the space. In yet other embodiments the space is started based on photos, then customized to ensure necessary inclusion of elements such as picture frames. As these spaces are created any number of different objects could be made to be interactable. This means that for example, a fridge could be opened revealing food products. When a user selects a food item, it is ordered to their room. Items could be ordered in any variety of manners. In one embodiment where the user is in an assisted living home, the home will get a notification to deliver the item. In other embodiments food could be ordered via a third party app such as Grubhub®.

In other embodiments different interactions and interactable items may be used. For example, a team affiliated sports poster could have a pre-defined URL embedded therein. This URL could take a user to the teams official store where they would have the ability to purchase merchandise. In another embodiment a blanket is made interactable. In this embodiment a pre-defined URL is embedded such that when a user clicks on the blanket Amazon® is opened to a search for blankets. This would then allow a user to purchase blankets.

In each embodiment several items may be placed in the rooms to allow a user to view media. In one embodiment at least one picture frame 101 is placed in the room to allow for a user to view photographs. In another embodiment a television 102 is placed in the room to allow a user to view videos. In yet a third embodiment, a radio 103 is placed in the room to allow a user to listen to recordings. In one embodiment the radio 103 could also be used to adjust a volume.

These rooms or spaces will be created to allow the user to experience comforts of home even when located in a new space. Further, by allowing other items to be interactive it can further enhance a user's experience. As detailed below there are different users whom may also add content for viewing.

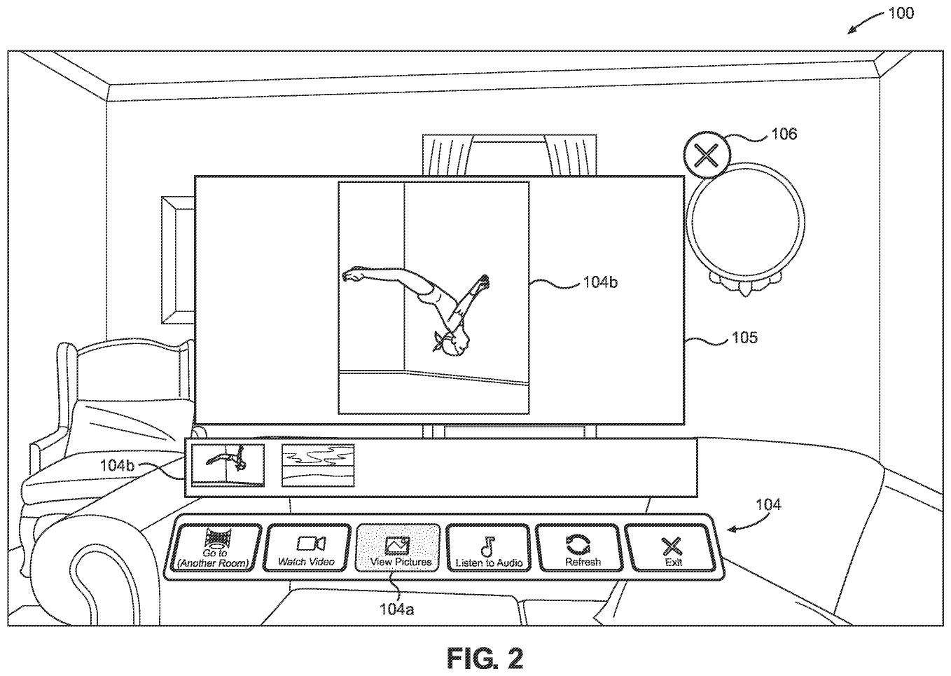

Referring now to FIG. 2, there is shown a screen capture of another embodiment of a room created for us on virtual reality device of the virtual reality memory bank. In this embodiment there is still a 360 degree virtual location 100. In this shown embodiment the 360 degree virtual location 100 is a sitting room. In various embodiments the 360 degree virtual location 100 may include items such as televisions, picture frames or radios. However, in this embodiment these items are not needed for viewing media assets.

In this embodiment there is menu bar 104 displayed on the screen. The menu bar has at least one selection button 104a thereon. In this embodiment when a desired selection button 104a is pressed the associated media 104b will then be displayed in a small display. From there media 104b may be selected for display on a larger pop-up screen 105. In one embodiment when the user no longer wishes to view or listen to the selected media the 104b the pop-up screen 105 can be closed using the exit button 106.

In one embodiment the user can use the electronic device in order to move to another room within a 360 degree virtual location 100. In another embodiment the user can walk to an entirely new 360 degree virtual location 100. In this embodiment the user can enter a new 360 degree virtual location 100 but using the menu buttons 104a in order to select a new location to visit.

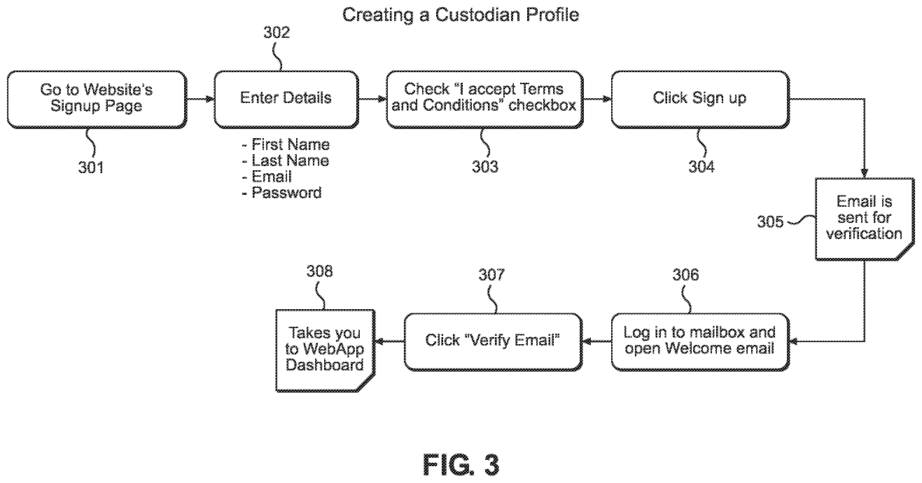

Referring now to FIG. 3, there is shown a flow chart of one embodiment of creating a profile for the virtual reality memory bank. In order for the system to be individualized an initial profile must be created. In one embodiment the system with a control profile, and then other contributor profiles below that and end users below that. This will allow for one centralized user to control the system for the selected end users.

In order for a control profile to be created, in this embodiment referred to as a custodian profile, one must navigate to the proper page 301. Once on the page, signup is selected and the user will be able to enter personal details 302. In the shown embodiment the custodian will enter their first name, last name, email, and a password. In another embodiment, additional, or different information will be added. For example, a custodian may enter a phone number, a digital wallet ID or a social media profile name. In one embodiment the custodian will also accept terms and conditions 303. They will then click a button that will initiate the sign up 304.

In one embodiment the custodian must be verified 305. Here, the custodian's email will be verified. The user will receive an email which will be sent to the desired email address. In other embodiments the verification may come in the form of a text message, voice call, or authentication app prompt. The user must log into the email and open the email 306. In other embodiments the user may need to open a text answer the call or open the application. The user will be able to click a link in an email sent by the system to verify the email 307. In another embodiment the user may confirm identity by using any of the previously mentioned forms of authentication. The verification may include the need to enter or response to questions about personal information entered previously. Once verified the custodian user will be taken to the “Dashboard” 308. From the Dashboard various items will be accessible.

In one embodiment the Dashboard will have an information collection point. In one embodiment the information collection point will allow for a user to input information such as: the names of users, the current and past locations of users, favorite activities of users, favorite songs of users, and other such relevant information. This will allow for custodians and contributors to be able to upload media which is better suited to the user.

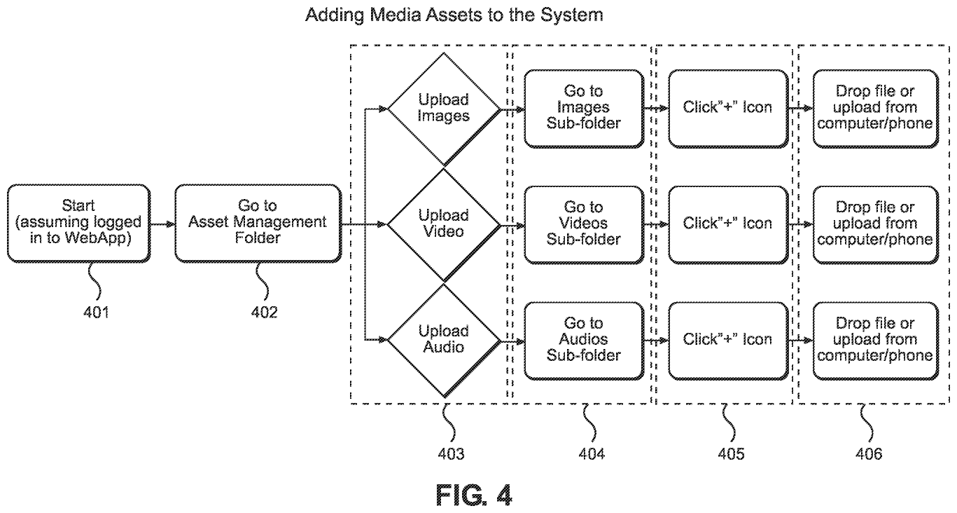

Referring now to FIG. 4, there is shown a flow chart of one embodiment of adding media to the system to be displayed by the virtual reality memory bank. Media assets can be added to the system in many different ways. In one embodiment the method to add media begins once a user is logged in 401. Once logged in a user will navigate to the desired location to start the method 402. In the shown embodiment the location is titled “Asset Management.” In different embodiments media may be added to different locations. In one embodiment media is added to a single location. In other embodiments media is added by type. All media types may be added in the same way.

In the shown embodiment media is added by type. The user will select what type of media to upload 403, and then the user navigates to the desired media type folder 404. In one embodiment there is no need to go to a subfolder and a user may upload media from any proper location. Once there, the user must select the upload button 405. In the shown embodiment the button is a “+.” In one embodiment the media can be dropped into the location. In another embodiment the media is found in a current folder location and copied to the media location 406. In yet a further embodiment a user may elect to take a new photo, video, or record new audio for immediate upload.

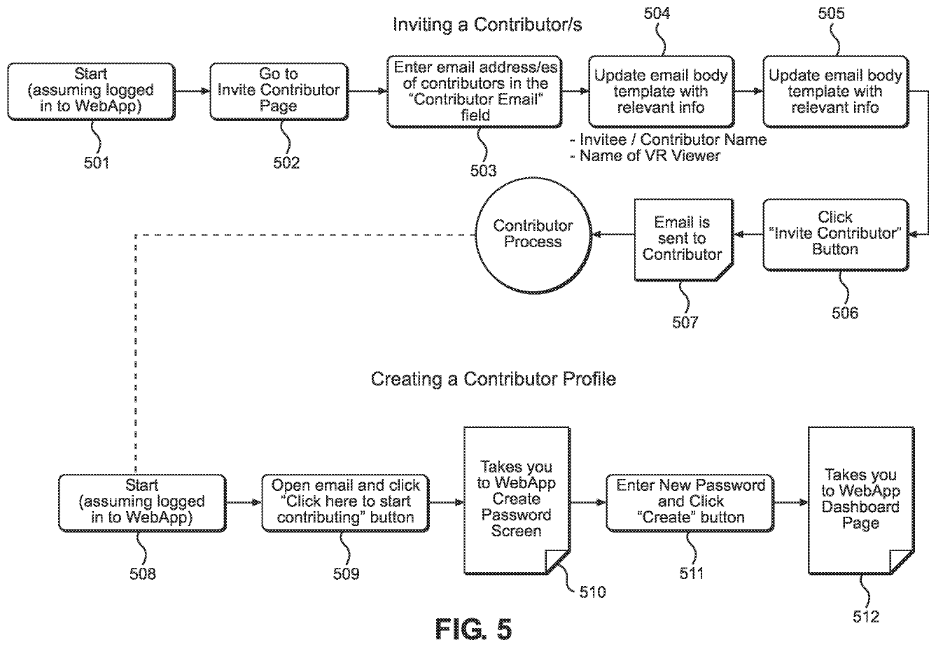

Referring now to FIG. 5, there is shown a flow chart of one embodiment of adding a user to the system for the virtual reality memory bank. In different embodiments users or contributors can be added. In different embodiments these users or contributors may be associated with one custodian or multiple custodians. In the shown embodiment the method starts once the custodian is logged in to the system 501. Once logged in the custodian begins the method by going to the desired page or location 502. In the shown embodiment the page is titled “Invite Contributor” 502. Once there the custodian must enter a contributor identifier 503. In the shown embodiment a contributor's email address is used 503. In another embodiment a user may enter additional information such as: a phone number, a digital wallet ID or a social media profile name. In one embodiment a message template is generated 504. In another embodiment a custom message must be created. In either embodiment the custodian may edit the message 505. In one embodiment the message is an email. In another embodiment the message is a text message. Once the message is prepared the custodian must initiate the invitation process 505. In the shown embodiment this is represented by clicking the “Invite Contributor” button 506. After the invite has been initiated an email or other message will be sent to the contributor 507.

Once the invitation process has been initiated, the next steps will be for the contributor to continue. In one embodiment the contributor will log into the webapp via the profile previously created 508. In another embodiment the contributor will be able to skip the login process altogether. The contributor will receive the message. In one embodiment the contributor will accept the invitation by clicking on a link within the message 509. In the shown embodiment the link will take the contributor to a location to create a password for future access to the system which the contributor has been invited to 510. The contributor must then enter a new password and create the password 511. Once accepted into the system the contributor will be taken to the dashboard where they may perform allowed tasks 512.

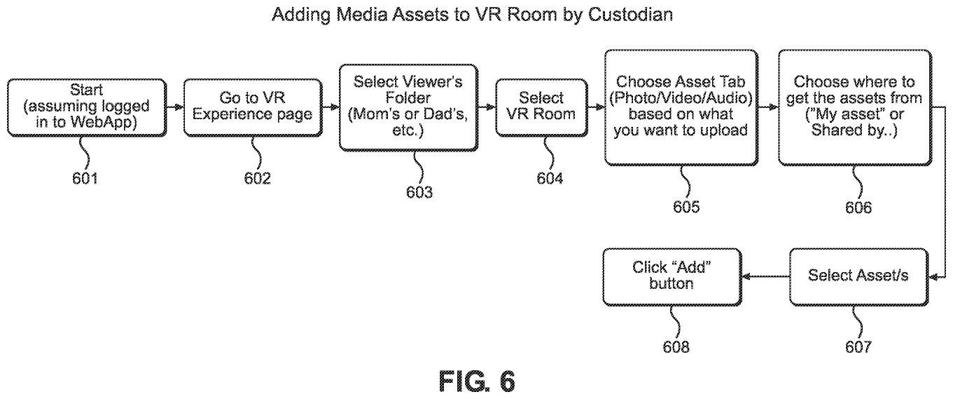

Referring now to FIG. 6, there is shown a flow chart on one embodiment of managing the virtual reality experience of the virtual reality memory bank. In one embodiment, to add media or remove media which can be viewed from the memory bank the following steps are used. The method starts once the custodian has logged in 601. Next, they visit a specified web page or location 602. In this embodiment the location is titled “VR Experience.” Next the custodian will select the desired viewer 603. In some embodiments there will only be one viewer to choose from. Once the viewer is selected, a room must then be chosen 604. This will allow for different media assets to be placed into different rooms assigned to the same user.

Next a media asset must be chosen 605. In some embodiments media assets will be separated by type. In other embodiments all media will be grouped into one place. In yet other embodiments the custodian may choose where to access the folder from 606. Once the asset(s) are selected 607 the custodian will click an add button 608. This will place the media in the desired location for viewing by the user.

One benefit to the present system is the change between how to share media in this system and the old ways of having to share media as it pertains to virtual reality systems. In the current model, a first user must share media to a social networking platform. A second user, the one the first user intended to share the media with, must then log in to their same social media platform on the virtual reality machine. The second user must then search for and locate the shared media. This will allow for the second user to view the media. In the present system a first user may share media directly to a location for the second user to view the media. This significantly simplifies the process. Further neither party is required to have a social media account.

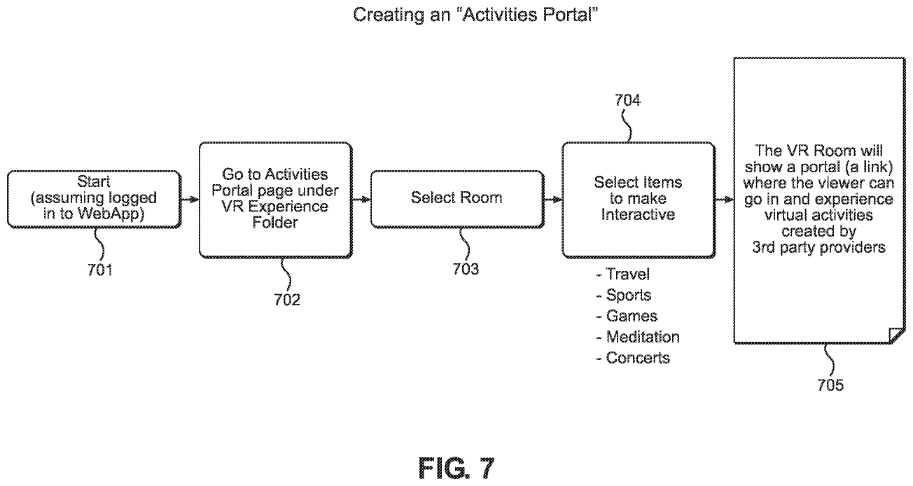

Referring now to FIG. 7, there is shown a flow chart of one embodiment of enhancing the virtual reality experience of the virtual reality memory bank. In one embodiment a custodian will be able to create a more interactive experience for the user. In the shown embodiment a custodian logs in 701. The custodian then goes the desired page to enhance the user experience 702. The custodian must then select a room 703. Once the room is selected the custodian may then select items in a room to become interactive 704. The custodian may also selected interests of the user and links for the selected items 704. In one embodiment these links may be created by third parties and direct a user to an advertisement or a shopping area 705.

In another embodiment the system automatically selects items and connects links to these items. In this embodiment the system may deploy AI image and text recognition in order to match items with appropriate links. In different embodiments links may be capable of a multitude of different interactions.

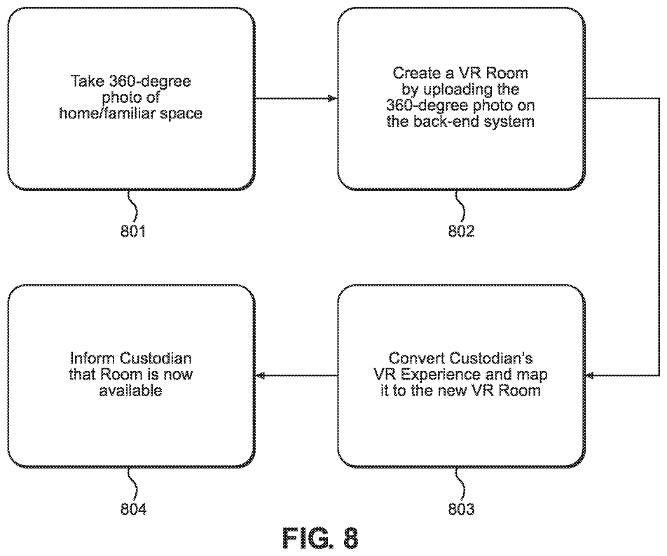

Referring now to FIG. 8, there is shown a flow chart of an embodiment of a method for creating a custom room and granting access to the same. The method starts by taking a 360-degree photograph of the home or room to be created 801. In some embodiments multiple photographs will be needed. Next the photo(s) must be uploaded to the webapp so that the room can be digitally created 802. After the room is digitally created the proper individuals are given access the room 803. In one embodiment the custodian of the room is notified that the room is created 804.

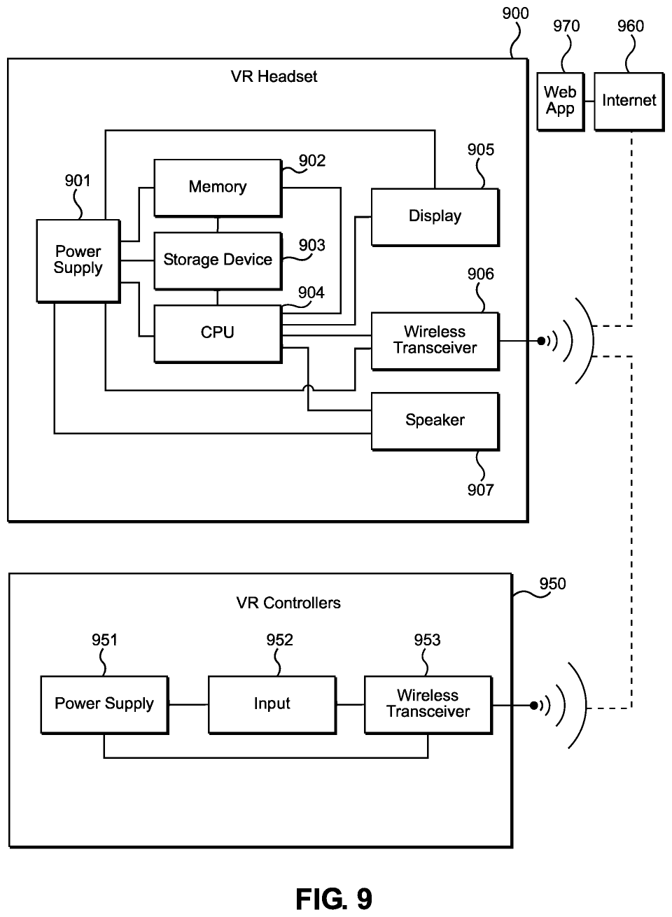

Referring now to FIG. 9, there is shown a wiring diagram of an embodiment of a virtual reality system. In one embodiment the virtual reality system includes a VR headset 900 and at least one controller 950. In the shown embodiment the virtual reality headset 900 includes a power supply 901. The power supply 901 will ensure that no extra cords are needed. In one embodiment the power supply 801 is a rechargeable battery. This will allow for continued use of the power supply 901.

The power supply 901 is operably coupled to each of the components of the virtual reality head set 900. In one embodiment the components include a memory 902 which is operably coupled to a storage device 903. In one embodiment the storage device 903 is a solid state hard drive. The memory 902 and the storage device 903 are operably coupled to a CPU 904.

The CPU 904 is operably coupled to several additional devices. The CPU is operably coupled to a display 905. The display 905 is configured to be over the eyes when placed in the virtual reality head set 900. The CPU is further coupled to a speaker 907. This will allow for the virtual reality headset 900 to produce sound fully immersing the user in the experience. In some embodiments the CPU 904 is operably coupled to a wireless transceiver 906. In one embodiment the wireless transceiver 906 will allow the virtual reality headset 900 to connect to the internet 960. In one embodiment the internet connection 960 will allow the virtual reality headset 900 to connect to the web app/web site 970. In another embodiment the wireless transceiver 906 will allow the virtual reality headset 900 to connect to at least one controller 950.

In one embodiment there is a single controller 950 which will allow a user to control the virtual realty device. In another embodiment there is a plurality of controllers 950 which allow a user to control the virtual reality device. In different embodiments the controllers 950 are handheld; in other embodiments the controllers are made up of other components such as a treadmill. This availability of different controllers 950 will allow for different immersive experiences.

In each embodiment a controller 950 will include at least a power supply 951. In some embodiments the power supply 951 is internal. In other embodiments the power supply 951 is external and not part of the controller 950 but supplies power in the same manner as an internal power supply 951.

The power supply is connected to an input device 952. In some embodiments the input device 952 is a button. In some embodiments there is a plurality of input devices 952 included in each controller 950. In other embodiments other input devices 952 may be used. In one embodiment the input devices 952 are connected directly to a wireless transceiver 953. This will transmit the inputs from the controller 950 to the CPU 904 of the virtual reality headset 900. In another embodiment the controller 950 may include its own CPU to process the inputs before they are sent to the virtual reality headset 900.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method for a virtual reality memory bank, the method comprising:
creating a 360-degree virtual location, wherein the virtual location is displayed on a virtual reality headset;
including within the location at least one visual media outlet;
displaying via the at least one visual media outlet desired visual media;
including within the location at least one audible media outlet;
playing via the audible media outlet desired audible media.

2. The method for a virtual reality memory bank of claim 1, wherein the virtual location is created from a physical location.

3. The method for a virtual reality memory bank of claim 1, wherein the visual media outlet is a television.

4. The method for a virtual reality memory bank of claim 1, wherein the audible media outlet is a radio.

5. The method for a virtual reality memory bank of claim 1, further comprising:
taking a 360-degree photograph of a physical location, wherein the 360-degree virtual location is created using the 360-degree photograph.

6. The method for a virtual reality memory bank of claim 1, wherein access to the 360-degree virtual location is restricted.

7. The method for a virtual reality memory bank of claim 7, further comprising accessing the 360-degree virtual location via a user name and password.

8. The method for a virtual reality memory bank of claim 7, wherein multiple persons have access to a single 360-degree virtual location;

9. The method for a virtual reality memory bank of claim 8, wherein different persons have different access permissions.

10. The method for a virtual reality memory bank of claim 9, wherein selected persons may add selected media assets to a virtual database for display via at least one of the visual media outlet and the audible media outlet.

11. The method for a virtual reality memory bank of claim 1, further comprising:
selecting virtual items displaying within the 360-degree virtual location to be interactive.

12. The method for a virtual reality memory bank of claim 11, further comprising:
selecting a desired action which will be performed when the virtual item is selected.

13. The method for a virtual reality memory bank of claim 1, further comprising creating a second 360-degree virtual location, wherein the second 360-degree virtual location is accessible via the 360-degree virtual location.

14. The method for a virtual reality memory bank of claim 6, further comprising creating a second 360-degree virtual location, wherein the second 360-degree virtual location is accessible via the 360-degree virtual location.

15. The method for a virtual reality memory bank of claim 12, wherein a desired action of an item includes ordering food.

16. The method for a virtual reality memory bank of claim 12, wherein a desired action includes directing a user of the virtual reality memory bank to an online shop.

17. The method for a virtual reality memory bank of claim 6, wherein a single user is granted permissions to monitor and control access to the 360-degree virtual location.

18. The method for a virtual reality memory bank of claim 17, wherein the single user invites additional users to the 360-degree virtual location.
